(19) United States
(12) Patent Application Publication
(10) Pub. No.: US 2003/0200128 A1
(43) Pub. Date: Oct. 23, 2003

(54) Displaying items of information

(76) Inventor: Sean Matthew Doherty, Beecroft New South Wales (AU)

Correspondence Address: FITZPATRICK CELLA HARPER & SCINTO, 30 ROCKEFELLER PLAZA, NEW YORK, NY, 10112, US

(21) Appl. No.: 09/523,193

(22) Filed: Mar. 10, 2000

(30) Foreign Application Priority Data
Mar. 16, 1999 (AU) PP9235

(51) Int. Cl. G06F 17/60

(52) U.S. Cl. 705/8; 705/14

(57) ABSTRACT

A method of scheduling items of information is disclosed, where each item of information has an associated priority that is a function of time. The method comprises scheduling (240, 250, 260) items of information in accordance with the values of said priorities, and activating (200) a user interrupt in response to user input. The method then schedules (280, 240, 250, 260) items of information in accordance with the values of said priorities at a time after termination of the user interrupt.

### FIELD OF INVENTION

The present invention relates to a method and apparatus for displaying items of information on a display apparatus. The present invention also relates to a method and apparatus for scheduling items of information. The present invention also relates to a c a computer readable medium comprising a computer program for displaying items of information on a display apparatus. The present invention still further relates to a a computer readable medium comprising a computer program for scheduling items of information.

### BACKGROUND OF INVENTION

A large portion of advertising today involves broadcasting to a large audience. For advertisers that target a large portion of the population this may be appropriate, but for smaller advertisers these methods are not always appropriate. Any method which allows advertisers to cost effectively target a smaller, more specific audience will be beneficial. As the cost of technology continues to reduce, it is now foreseeable to have many small public displays that advertise to smaller, more localised audiences.

The advertising in these displays would be more effective if they could draw the attention of the audience to the displays. Displaying interesting information, such as news and weather could create interest in the audience. Providing a user interface, which allows the user to interact with the system could also create interest. However, when user interaction is combined with scheduled advertisements, problems arise appropriately scheduling the advertisements around the unpredictable user interaction.

To assist in targeting the appropriate audience, it would also be advantageous to base the scheduling of advertisements not only on time alone, but also on conditions such as location, user interaction and any other events that can be monitored.

U.S. Pat. No. 5,664,948 entitled “DELIVERY OF DATA INCLUDING PRELOADED ADVERTISING DATA” describes a system and method for the presentation of advertisements in a moving vehicle. In this patent, the described method for scheduling advertisements involves selecting advertisements in response to events such as time and location of the vehicle and then placing the advertisements into a queue. In the event that a system interrupt occurs which takes control of the output devices, such as an interrupt responding to user interaction, the queue would have to be delayed. This could result in the queue becoming undesirably long and queued advertisements may not get played under the conditions they were intended to be played. Furthermore, advertisements are selected on a first picked first served basis that may or may not result in the most appropriate advertisement being played.

### SUMMARY OF THE INVENTION

It is an object of the present invention to ameliorate one or more disadvantages of the prior art.

According to a first aspect of the invention, there is provided a method of scheduling items of information, wherein each item of information has an associated priority which is a function of time, the method comprising the steps of: (a) scheduling items of information in accordance with the values of said priorities; (b) activating a user interrupt in response to user input; and (c) scheduling items of information in accordance with the values of said priorities at a time after termination of the user interrupt.

According to a second aspect of the invention, there is provided a method of displaying items of information on a display apparatus comprising a display unit and an user interface, wherein each item of information has an associated priority which is a function of time, the method comprising the steps of: (a) scheduling items of information in accordance with the values of said priorities; (b) generating a user interrupt in response to a user interacting with the user interface; (c) clearing said scheduled items of information in response to the user interrupt; (d) estimating a time the user will finish interacting with the user interface; (e) scheduling items of information in accordance with the values of said priorities at a said estimated time; (f) repeating steps (d) to (e), if the user is still interacting with user interface at the estimated time; otherwise (g) displaying said scheduled information according to their priority.

According to a third aspect of the invention, there is provided apparatus for scheduling items of information, wherein each item of information has an associated priority which is a function of time, the apparatus comprising: means for scheduling items of information in accordance with the values of said priorities; means for activating a user interrupt in response to user input; and means for scheduling items of information in accordance with the values of said priorities at a time after termination of the user interrupt.

According to a fourth aspect of the invention, there is provided apparatus for displaying items of information on a display apparatus comprising a display unit and an user interface, wherein each item of information has an associated priority which is a function of time, the apparatus comprising: first scheduler means for scheduling items of information in accordance with the values of said priorities; generator means for generating a user interrupt in response to a user interacting with the user interface; clearance means for clearing said scheduled items of information in response to the user interrupt; estimation means for estimating a time the user will finish interacting with the user interface; second scheduler means for scheduling items of information in accordance with the values of said priorities at a said estimated time; repetition means for repeating the operations of the estimation means, and second scheduler means, if the user is still interacting with user interface at the estimated time; and display means for displaying said scheduled information according to their priority, if the user is not interacting with user interface at the estimated time.

According to a fifth aspect of the invention, there is provided a computer readable medium comprising a computer program for scheduling items of information, wherein each item of information has an associated priority which is a function of time, the computer program comprising: code for scheduling items of information in accordance with the values of said priorities; code for activating a user interrupt in response to user input; and code for scheduling items of information in accordance with the values of said priorities at a time after termination of the user interrupt.

According to a sixth aspect of the invention, there is provided a computer readable medium comprising a computer program for displaying items of information on a display apparatus comprising a display unit and an user interface, wherein each item of information has an associated priority which is a function of time, the computer program comprising: first scheduler code for scheduling items of information in accordance with the values of said priorities; generator code for generating a user interrupt in response to a user interacting with the user interface; clearance code for clearing said scheduled items of information in response to the user interrupt; estimation code for estimating a time the user will finish interacting with the user interface; second scheduler code for scheduling items of information in accordance with the values of said priorities at a said estimated time; repetition code for repeating the operations of the estimation code, and second scheduler code, if the user is still interacting with user interface at the estimated time; and display code for displaying said scheduled information according to their priority, if the user is not interacting with user interface at the estimated time.

### BRIEF DESCRIPTION OF THE DRAWINGS

Embodiments of the invention are described with reference to the drawings, in which:

FIG. 1 shows a block diagram of an information display apparatus in accordance with a preferred embodiment;

FIG. 2 shows a flow diagram of a scheduling process in accordance with a preferred embodiment as used in the information display apparatus of FIG. 1;

FIGS. 3a to 3d show examples of a time priority profile in accordance with a preferred embodiment;

FIG. 4 shows another example of a time priority profile in accordance with a preferred embodiment;

FIG. 5 shows another example of a location priority profile in accordance with a preferred embodiment;

FIG. 6 shows an example of the scheduling of items of information and their associated priorities in accordance with a preferred embodiment;

FIG. 7 shows a process for determining total priority under multiple conditions that can be used in the scheduling process of FIG. 2;

FIG. 8 shows a flow diagram of a compiling process as used in the information display apparatus of FIG. 1; and

FIG. 9 shows a flow diagram of a user interrupt process as used in the scheduling process of FIG. 2; and

FIG. 10 shows the operational relationship between the scheduler, output compiler and output devices during a user interrupt in accordance with a preferred embodiment.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

The preferred embodiment provides a preferred apparatus and method for the display of items of information designed for small and localised audiences. In particular, the preferred embodiment provides a scheduling method for scheduling items of information, which may include advertisements. These items of information may be based on conditions such as location, user interaction in addition to other definable events. During the process of scheduling an item of information, the current conditions are used to determine which item of information would get the most value out of being scheduled at that particular time. To do this, the system determines the priority of each item of information in the data base under the conditions at the particular time and selects the item of information with the highest priority. This method can be implemented on the run, so that items of information can be scheduled around unpredictable user interaction. During this processing, a user interrupt will be generated in response to a user interacting with the user interface. The schedule of items of information will be cleared in response to such a user interrupt and a time is estimated on how long the user will interact with the user interface. The process will then schedule items of information for the current estimated time. If the user is still interacting with the user interface at the end of the current estimated time, then the process will again clear the schedule, estimate a further time and schedule items of information for the next estimated time. This continues until the user is finished with the user interface and the process will then display the scheduled items of information at the current estimated time according to their priority. In this way, the preferred embodiment is a more flexible system, in that each advertisement is prioritised at a particular instant in time rather than placing them in a queue. Thus avoiding long queues and inappropriate items of information being displayed.

Whilst the preferred embodiment is described with reference to a generic application, it has, due to its nature, a multitude of applications. For example, the preferred embodiment may be used in a public transport environment such as taxis, buses, trains and aeroplanes for displaying timetables and/or advertisements. The preferred embodiment may also be used in public waiting areas, such as in airports, train stations, bus stops, doctors surgeries, lifts etc. Furthermore, the preferred embodiment may also be used in shops, canteens and billboards.

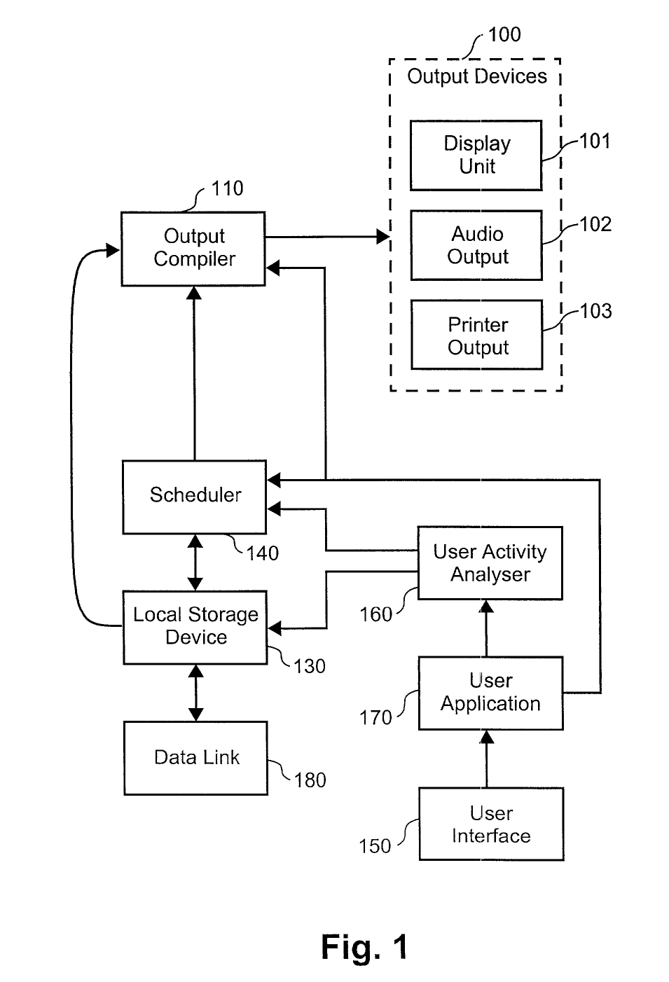

FIG. 1 shows a block diagram of an information display apparatus 1. The apparatus 1 comprises a number of output devices 100, a user interface 150, a user application module 170, a user activity analyser 160, a Scheduler 140, local storage device 130, datalink 180, and output compiler 110. Advertising and other items of information are output through the output devices 100 such as a conventional display unit 101, audio output 102 and a printer output 103. The display unit 101 displays information and advertisement videos, animations, images or text. The display unit 101 would also be used to display any menus required to show the options that the system may present to the user at various times. Audio output 102 may be used to support the video information in the display unit 101 where audio is desirable. Information leaflets and advertisement coupons could be printed out through the printer output 103. Information leaflets could include news, maps, phone numbers, addresses, etc for the user. Coupons designed by the advertisers would also provide a feed back mechanism for the advertisers.

All output to the output devices 100 is compiled into a suitable format by any conventional output compiler 110. The output compiler 110 obtains a reference to an advertisement from a schedule supplied by the scheduler 140 and uses the reference to obtain the advertisement data from the local storage device 130, which contains the database of advertisements. The output compiler 110 renders text in addition to image and video output from standard formats such as JPEG and MPEG as well as other more compact formats, which in a trade off for their more compact storage size, would require more compilation time than the standard formats. The output compiler 110 also carries out decoding and synthesis of sound data and information. The output compiler 110 can also be adapted to output the advertisements and other items of information in a suitable format for multi-displays.

The scheduler 140 outputs a schedule, which will be discussed in more detail later. The scheduler 140 records a log of advertisements and other items of information to be scheduled and displayed by the output devices 100. The actual advertisements and other items of information are stored in the local storage device 130.

The user interacts with the apparatus 1 through the user interface 150. The user interface 150 is implemented using a few buttons or a more detailed touch screen or keyboard interface. In the case of a touch screen, the user interface 150 is tied in with the display unit 102. The user interacts with the user application module 170 through the user interface 150. Once the user commences interacting with the user interface 150, a user interrupt is generated by the user application module 170. The user interrupt is supplied to the scheduler 140, in response to which the schedule is cleared and rescheduling is undertaken. The user interrupt is also supplied to the output compiler 110, in response to which the presently displayed advertisements or other items of information are terminated and a menu associated with the user application module is displayed. The operation of the user application module 170 will be described below in more detail.

Preferably, the embodiment comprises a user activity analyser 160. However, the present invention is not limited to such a device, and it may be dispensed with in some implementations. The user activity analyser process 160 monitors the user interaction. By detecting the presence of a user and monitoring the user interaction, a user profile 170 is developed which can assist the scheduler 140 to schedule the most appropriate advertisements or other items of information for the user. For example, if the user accesses a menu for restaurants, the user profile 170 would indicate the user's interest in restaurants. This could be implemented by recording the key word “restaurant” along with the time that the user accessed the restaurant menu. The recording of the time with the key word is important, as such permits the influence that the key word has on the operation of the scheduler 140 to be altered, for example reduced, over time. Such a reduction or decay may be implemented by any function that decreases in value as the time since the key word was added increases. If the user accesses the restaurant menu again, the apparatus would either update the time value of the existing “restaurant” key word entry or alternatively add a totally new record.

A new user profile is produced and used if the user activity analyser 160 determined that the current user had finished or gone away. The analyser 160 may determine this via a presence sensor such as an infra red sense or weight sensor, or alternatively using a time out routine where the user analyser 160 monitors the time since the user last interacted with the system. A new user profile may also be used when events related to the user status occur. For example, resetting the fare meter in a taxi, would indicate that the current user has left the taxi and hence would be an appropriate time to create a new user profile 170. Each user profile 170 developed is preferably stored in the local storage device 130, so that system administrators may provide feedback on the system usage for themselves as well as for the advertisers.

All persistent information is stored in, and accessed from the local storage device 130. The information in the local storage device is updated and read externally using a data link 180. The data link would be implemented as a high bandwidth link using a cable connection or alternatively via a lower bandwidth wireless connection such as a radio link or cellular telephone network. The high bandwidth link would only allow updates where a physical connection could be made. In an information display apparatus used in a passenger bus, data may be updated daily at the bus depot. In taxis, data may be updated at service stations. The wireless connection would allow more frequent remote updates and would be useful where a regular physical connection was not feasible. The wireless connection is disadvantaged by the lower bandwidth.

In some cases the data link 180 may provide access to the Internet so that the information display apparatus can obtain news and information for the user as well as data for system operation. Direct Internet access for the user could also be incorporated into the system.

Under normal operation, there are three concurrent processes running: the scheduler 140, the output compiler 110 and the control of the output devices 100. During user interaction, the user activity analyser 160 is also activated.

The processes performed by the user application module 170, scheduler 140 and the user activity analyser 160 may be implemented on a general-purpose computer. The user interface 150, local storage device 130, data-link 180, output compiler 110 and output devices 100 can also be implemented as peripheral devices interfacing such a general purpose computer. In particular, the steps of the processes performed by the scheduler 140, user application module 170 and the user activity analyser 160 can be effected by coded instructions in the software that are carried out by the computer. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for displaying items of information.

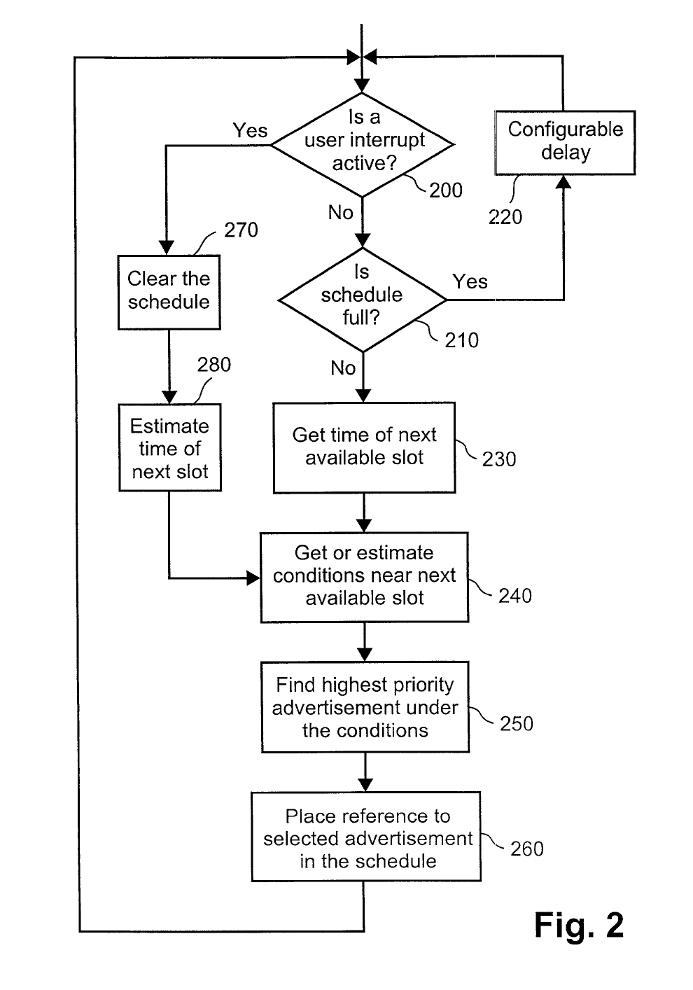

Turning now to FIG. 2, there is shown a flow diagram for the scheduling process performed by the scheduler 140 shown in FIG. 1. The scheduling process begins at decision block 200 to determine if the user is currently interacting with the apparatus. In the later circumstances, the user application module 170 generates a user interrupt which is supplied to the scheduler 140. If there is no user interrupt, then decision block 210 determines if the schedule 120 is full. Limiting the size of the schedule 120 restricts how far in advance the schedule 120 can forecast conditions, which helps keep the forecasts as accurate as feasibly possible. If the schedule 120 is full, the processing continues to step 220, which delays the process for a configurable amount of time before the schedule process is returned to the beginning of the loop. This loop then repeats until the schedule 120 is not full.

If the decision block 210 returns false (No), then the method continues processing at step 230. Step 230 gets the next available time slot, which starts after the last scheduled advertisement. The conditions are then obtained or estimated in step 240 so that the most suitable advertisement or other item of information can be selected in step 250. Conditions monitored would include location, time, user profile, available time to compile the output as well as other system parameters. A reference to the advertisement is placed in the schedule 120 by step 260 of the process. The scheduling process then returns to the start to schedule subsequent advertisements or other items of information.

If the user is interacting with the apparatus at the start of the scheduling process and consequently there is an active user interrupt the process continues to step 270. In this step 270, the schedule 120 is cleared. The estimate of the next available advertising time slot is obtained in the next step 280 by assuming that the user will finish in a relatively short time. The schedule 120 is cleared by step 270 because the time that the user interacts with the apparatus invalidates the existing schedule 120. If the estimate of when the user will be finished is too early, then the schedule 120 will be cleared next time the process starts and the time will be estimated again. Providing the estimate always is a relatively short time away, then the process will continue to clear the schedule 120 and re-estimate the time the user will be finished until the error in the estimate is relatively small.

Determining the most suitable advertisement involves the process of calculating the priority of each advertisement under the current conditions. Each advertisement in the database has a priority profile. The priority profile quantitatively describes the importance of playing an advertisement under the conditions. As the conditions will effect the importance of playing an advertisement, the priority profile could be a function of parameters at that particular time such as:

location or distance from a given location

user profile

frequency that the advertisement is played

time since it has last been played

number of times it has been played

advertising premium the advertiser is willing to pay

any other events which can be used in a priority profile function.

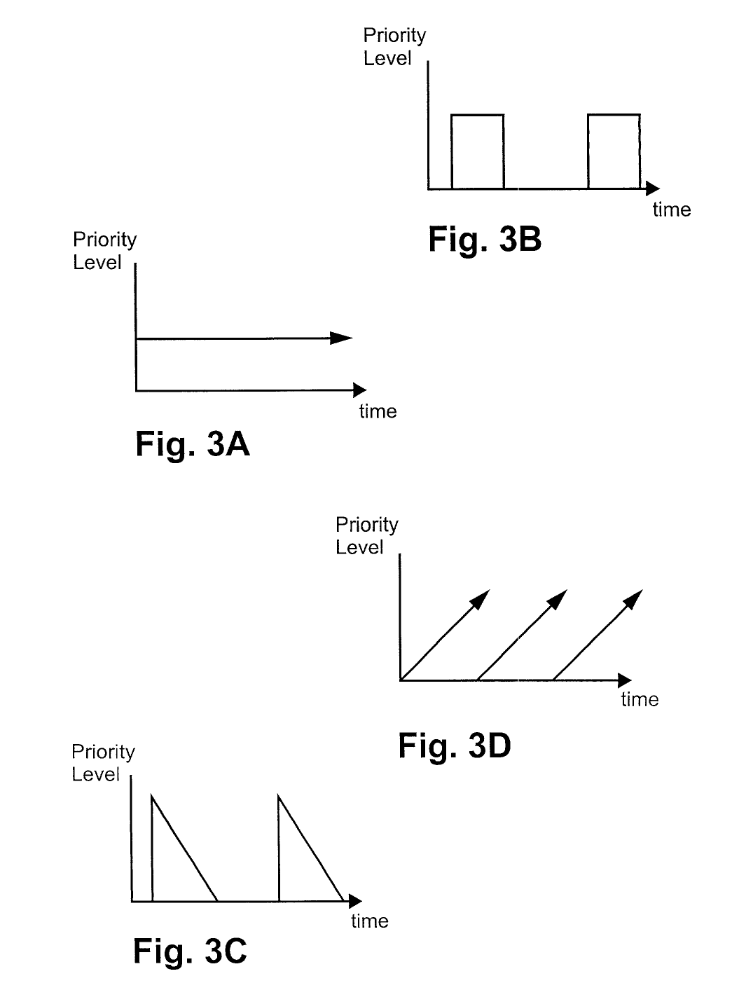

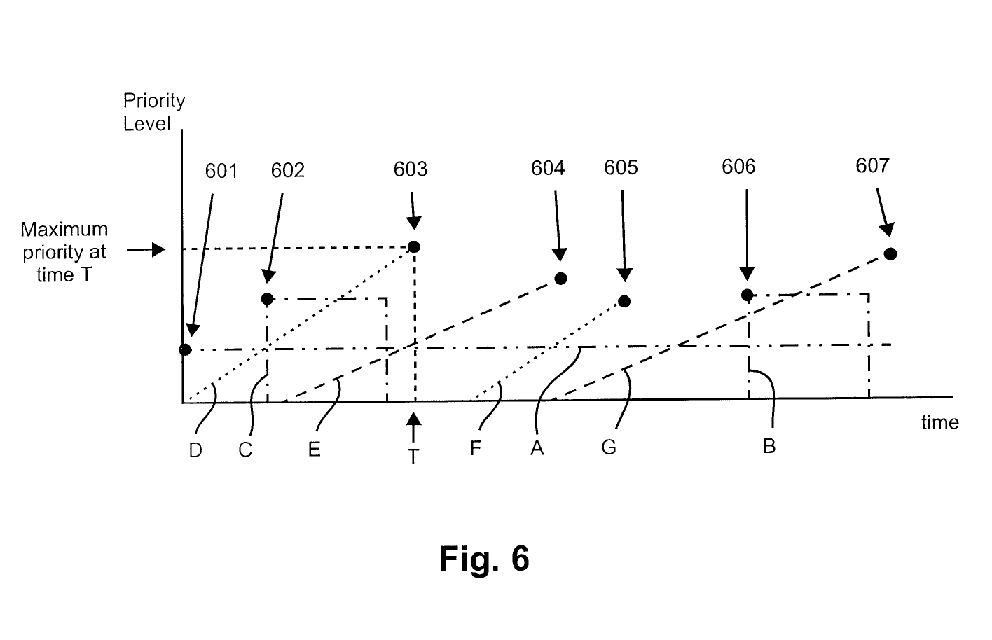

FIGS. 3A to 3D shows some examples of priority profiles that are a function of time only. An advertisement will be played if its priority level is the maximum of all advertisements in the database at that particular time, as shown and described with reference to FIG. 6. Hence the higher the priority level, the more likely that an advertisement is displayed. The priority level of an advertisement at the time that it is displayed may be related to the advertising premium that the advertiser has to pay.

A flat priority profile, as shown in FIG. 3A, is independent of the current conditions and will result in the advertisement being played only when the threshold priority level falls to it's priority level. This may be suitable for default advertisements or maybe for advertisers only willing to pay a set premium per advertisement. The rectangle profile in FIG. 3B is similar to the flat priority profile, but offers some time constraints on when the advertisement may be played. The triangle priority profile shown in 3C goes one step further than the rectangle priority profile by narrowing down the time which the advertisement can be played.

FIG. 3D describes a ramp profile. The ramp profile increases it's priority level with time and continues to do so until the advertisement is played, hence guaranteeing the advertisement is played. If the ramp priority profile is periodic, then the advertisements will be scheduled in with an average period approaching that of the priority profile.

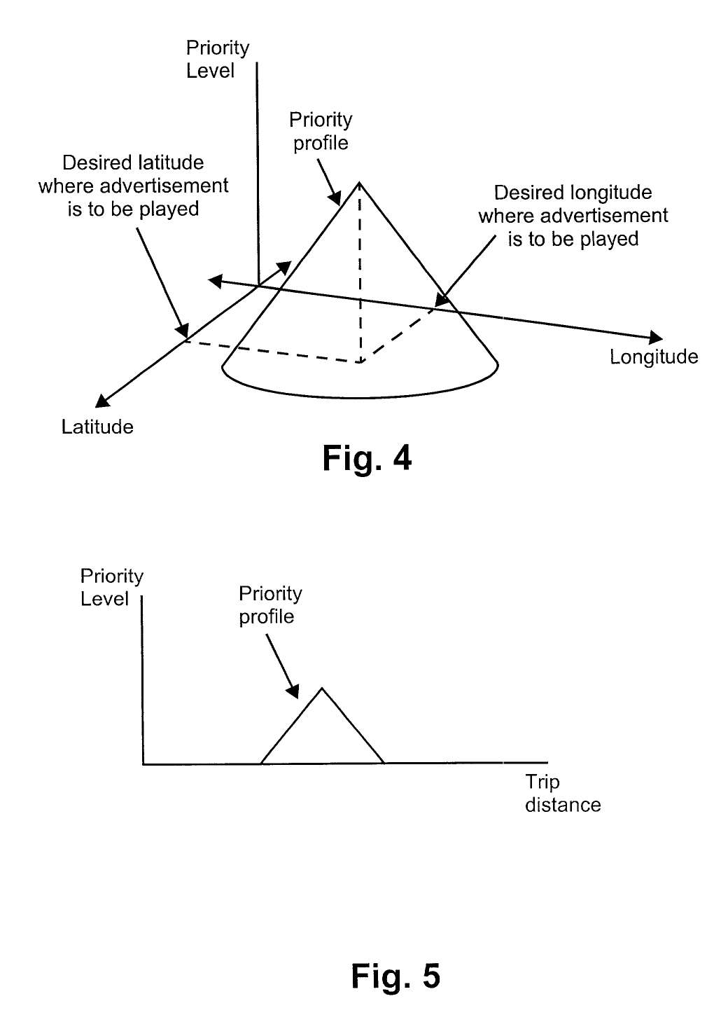

If location of the advertising system effects the priority of playing an advertisement, a priority profile based on longitude and latitude of the advertising system location would be used, as shown in FIG. 4. For example, if a taxi has the advertising and information system installed with an advertisement for a particular shop in the database, then the priority level for the shop advertisement would be increased as the taxi drives nearer to the shop. In the case where the trip route is defined, such as a train or bus journey, the location priority function may based on trip distance, rather than the coordinates of the vehicle. This is shown in FIG. 5.

FIG. 6 shows an example of the scheduling of items of information and their associated priorities. There are shown seven priority profiles A, B, C, D, E, F, and G as a function of time. The scheduling process at the next available time slot determines the maximum priority amongst all the seven priority profiles. Initially, the maximum priority is that of profile A. Consequently, the advertisement associated with profile A is scheduled to play at 601. The scheduling process will then schedule the next advertisement for the next available time, which is available after the completion of the advertisement A. In this particular example, the scheduling process determines for the next available time (602) that the maximum priority is that of profile C. Consequently, the advertisement associated with profile C is scheduled to play at 602. Similarly, the scheduling process schedules the advertisements associated with D, E, F, B, and G to play at times 603, 604, 605, 606 and 607 respectively.

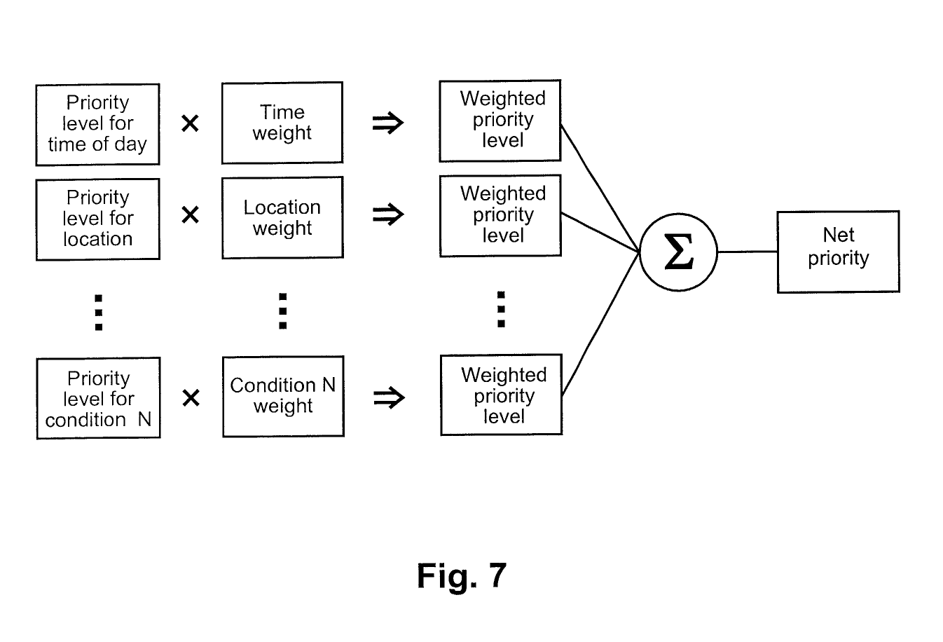

FIG. 7 shows a process for determining total priority under multiple conditions that can be used in the scheduling process of FIG. 2. To determine the overall priority for an advertisement under multiple conditions, each priority category could be weighted and then all of the weighted priority levels summed as shown in FIG. 7. This arrangement is similar to a simple neural network.

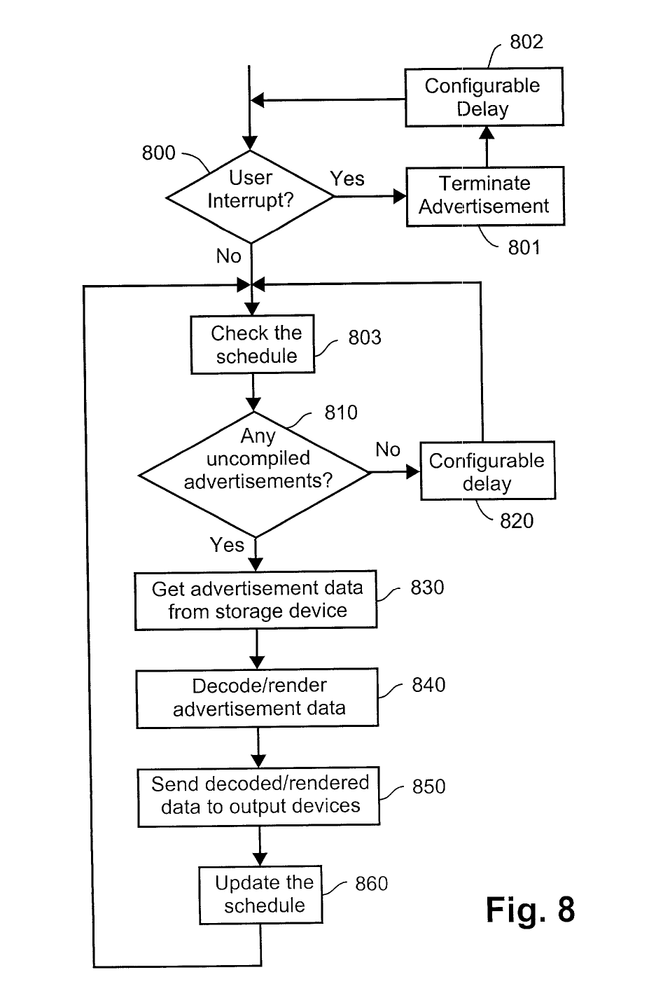

FIG. 8 shows the flow diagram for the output compiler 110. The output compiler 110 first checks in decision block 800 whether a user interrupt is active. If the decision block 800 returns true, then the processing continues to step 801, where the advertisement presently being compiled and rendered is terminated. The current advertisement is terminated so that the output devices can be made available to the user interrupt process. The termination may involve a transition between states so that the current advertisement is not abruptly stopped. After a configurable time delay 802, the process then returns to decision block 800. If the decision block 800 returns false, that is there is no user interrupt, the processing the continues to step 803.

The schedule in step 803 and decision block 810 determines if there are any uncompiled advertisements in the schedule. If there are none, the output compiler 110 waits for a configurable amount of time in step 820 before checking again. Once there is an advertisement to be compiled, step 830 retrieves the data from the local storage device 130 and step 840 decodes and renders the data where necessary. After decoding and rendering the data, step 850 then sends the data to the output devices 100 ready for output. The output compiler then updates the schedule in step 860 to indicate that the advertisement has been compiled. The process then starts again checking the schedule back in step 803.

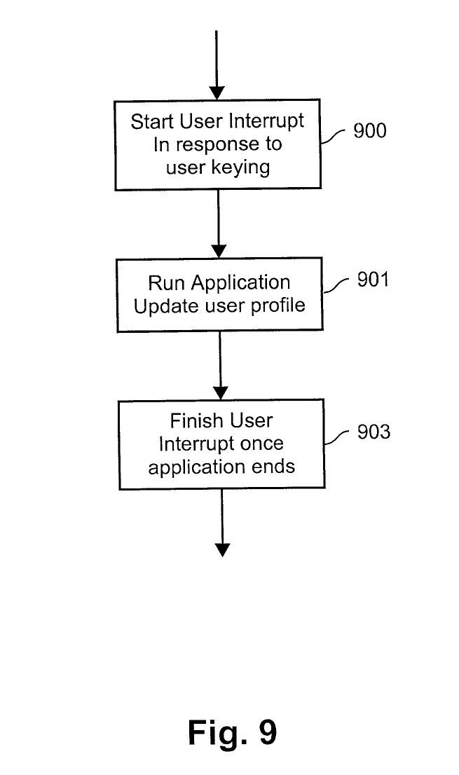

When a user commences interacting with the apparatus, a user interrupt is activated. The user interrupt process is described in the flow diagram in FIG. 9. The process commences in response to a user interaction with the user interface, such as keying in at a keyboard. In step 900, a user interrupt is activated in response to the user interaction. Then the application requested by the user is executed and run 901. During this period, the user interaction may be monitored for the purposes of updating the user profile. If the application, detects that the user is no longer present, or detects that here is a time out, then the user profile is updated and the application is terminated. After the termination of the application, the process continues to step 903 where the user interrupt is inactivated.

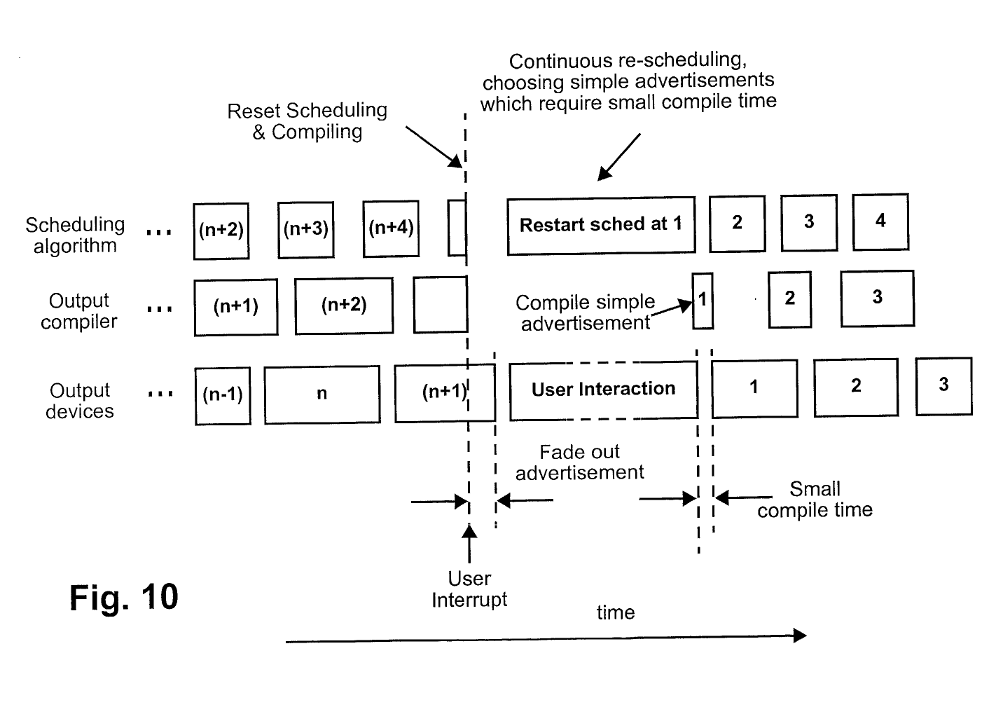

FIG. 10 shows how the scheduler 140, output compiler 110 and the output devices 100 are effected during a user interrupt. While the scheduling process 140 schedules advertisement (n+2), the output compiler 110 compiles advertisement (n+1) and the output devices 100 play advertisement (n−1) followed by advertisement n. This arrangement continues on until the user interrupt occurs, at which time the schedule 120 is cleared, the output compiler 110 stops and the output devices fade out the current advertisement. During the period of user interaction the scheduling process 140 continuously re-schedules the advertisements expecting the user to finish at any time. So that there is a minimal delay in system operation, during the continuous re-scheduling, the scheduler 140 where possible will select advertisements which require minimal compile time. Once the user interaction finishes, the output compiler 110 compiles the advertisement in the schedule 120 and upon completion the output devices 100 play the advertisement. Eventually, the apparatus returns to the normal operating state of scheduling, compiling and playing advertisements.

The foregoing only describes a small number of embodiments of the present invention, however, modifications and/or changes can be made thereto by a person skilled in the art without departing from the scope and spirit of the invention. The present embodiments are, therefore, to be considered in all respects to be illustrative and not restrictive.

We claim:

1. A method of scheduling items of information, wherein each item of information has an associated priority which is a function of time, the method comprising the steps of:
(a) scheduling items of information in accordance with the values of said priorities;
(b) activating a user interrupt in response to user input; and
(c) scheduling items of information in accordance with the values of said priorities at a time after termination of the user interrupt.

2. A method as claimed in claim 1, wherein said activating step (b) comprises the sub-step of:
(b)(i) estimating a time the user input will terminate; and said scheduling step (c) comprises the sub-step of:
(c)(i) scheduling items of information in accordance with the values of said priorities at said estimated time.

3. A method as claimed in claim 2, wherein if said user is still interacting at the end of the said estimated time, said method repeats said estimating (b)(i) and said scheduling step (c)(i) for a further estimated time.

4. A method as claimed in claim 1, wherein one or more said priorities are dependent upon one or more parameters as a function of time.

5. A method as claimed in claim 4, wherein one of said priorities is dependent upon the location or distance from a given location.

6. A method as claimed in claim 4, wherein one of said priorities is dependent upon the frequency the associated item of information is displayed.

7. A method as claimed in claim 4, wherein one of said priorities is dependent upon the time since the associated item of information was last displayed.

8. A method as claimed in claim 4, wherein one of said priorities is dependent upon the number of times the associated item of information has been displayed.

9. A method as claimed in claim 4, wherein one of said priorities is dependent upon on the cost of the associated item of information.

10. A method as claimed in claim 1, wherein said method further comprises the following steps:
monitoring the user input; and
generating a user profile based upon said monitoring.

11. A method as claimed in claim 10, wherein one of said priorities is dependent upon the user profile.

12. A method as claimed in claim 1, wherein said scheduling step (a) comprises:
(a)(i) determining the maximum priority of all the priorities of the items of information at the next available time for display;
(a)(ii) scheduling the item of information associated with said determined maximum priority as the item of information to be displayed at the next available time; and
(a)(iii) repeating steps (a)(i) and (a)(ii) for the next available time.

13. A method as claimed in claim 1, wherein said scheduling step (c)(i) comprises:
(c)(i)(1) determining the maximum priority of all the priorities of the items of information at the next available time for display;
(c)(i)(2) scheduling the item of information associated with said determined maximum priority as the item of information to be displayed at the next available time; and
(c)(i)(3) repeating steps (c)(i)(1) and (c)(i)(2) for the next available time.

14. A method of displaying items of information on a display apparatus comprising a display unit and an user interface, wherein each item of information has an associated priority which is a function of time, the method comprising the steps of:
(a) scheduling items of information in accordance with the values of said priorities;
(b) generating a user interrupt in response to a user interacting with the user interface;
(c) clearing said scheduled items of information in response to the user interrupt;
(d) estimating a time the user will finish interacting with the user interface;
(e) scheduling items of information in accordance with the values of said priorities at a said estimated time;
(f) repeating steps (d) to (e), if the user is still interacting with user interface at the estimated time; otherwise
(g) displaying said scheduled information according to their priority.

15. A method as claimed in claim 14, wherein one or more said priorities are dependent upon one or more parameters as a function of time.

16. A method as claimed in claim 15, wherein one of said priorities is dependent upon the location or distance from a given location.

17. A method as claimed in claim 15, wherein one of said priorities is dependent upon the frequency the associated item of information is displayed.

18. A method as claimed in claim 15, wherein one of said priorities is dependent upon the time since the associated item of information was last displayed.

19. A method as claimed in claim 15, wherein one of said priorities is dependent upon the number of times the associated item of information has been displayed.

20. A method as claimed in claim 15, wherein one of said priorities is dependent upon on the cost of the associated item of information.

21. A method as claimed in claim 14, wherein said method further comprises the following steps:
monitoring the user interaction with the user interface; and
generating a user profile based upon said monitoring.

22. A method as claimed in claim 21, wherein one of said priorities is dependent upon the user profile.

23. A method as claimed in claim 14, wherein said scheduling step (a) comprises:
(a)(i) determining the maximum priority of all the priorities of the items of information at the next available time for display;
(a)(ii) scheduling the item of information associated with said determined maximum priority as the item of information to be displayed at the next available time; and
(a)(iii) repeating steps (a)(i) and (a)(ii) for the next available time.

25. A method as claimed in claim 14, wherein said scheduling step (e) comprises:
(e)(i) determining the maximum priority of all the priorities of the items of information at the next available time for display;
(e)(ii) scheduling the item of information associated with said determined maximum priority as the item of information to be displayed at the next available time; and
(e)(iii) repeating steps (e)(i) and (e)(ii) for the next available time.

26. Apparatus for scheduling items of information, wherein each item of information has an associated priority which is a function of time, the apparatus comprising:
means for scheduling items of information in accordance with the values of said priorities;
means for activating a user interrupt in response to user input; and
means for scheduling items of information in accordance with the values of said priorities at a time after termination of the user interrupt.

27. Apparatus for displaying items of information on a display apparatus comprising a display unit and an user interface, wherein each item of information has an associated priority which is a function of time, the apparatus comprising:
first scheduler means for scheduling items of information in accordance with the values of said priorities;
generator means for generating a user interrupt in response to a user interacting with the user interface;
clearance means for clearing said scheduled items of information in response to the user interrupt;
estimation means for estimating a time the user will finish interacting with the user interface;
second scheduler means for scheduling items of information in accordance with the values of said priorities at a said estimated time;
repetition means for repeating the operations of the estimation means, and second scheduler means, if the user is still interacting with user interface at the estimated time; and
display means for displaying said scheduled information according to their priority, if the user is not interacting with user interface at the estimated time.

28. A computer readable medium comprising a computer program for scheduling items of information, wherein each item of information has an associated priority which is a function of time, the computer program comprising:
code for scheduling items of information in accordance with the values of said priorities;
code for activating a user interrupt in response to user input; and
code for scheduling items of information in accordance with the values of said priorities at a time after termination of the user interrupt.

29. A computer readable medium comprising a computer program for displaying items of information on a display apparatus comprising a display unit and an user interface, wherein each item of information has an associated priority which is a function of time, the computer program comprising:
first scheduler code for scheduling items of information in accordance with the values of said priorities;
generator code for generating a user interrupt in response to a user interacting with the user interface;
clearance code for clearing said scheduled items of information in response to the user interrupt;
estimation code for estimating a time the user will finish interacting with the user interface;
second scheduler code for scheduling items of information in accordance with the values of said priorities at a said estimated time;
repetition code for repeating the operations of the estimation code, and second scheduler code, if the user is still interacting with user interface at the estimated time; and
display code for displaying said scheduled information according to their priority, if the user is not interacting with user interface at the estimated time.
